(19) United States
(12) Patent Application Publication
(10) Pub. No.: US 2009/0274263 A1
(43) Pub. Date: Nov. 5, 2009

(54) Run-Time Meter With Blind Interface

(76) Inventor: Michael P. Collins, Plano, TX (US)

Correspondence Address: DUNLAP CODDING, P.C., PO BOX 16370, OKLAHOMA CITY, OK, 73113, US

(21) Appl. No.: 12/114,958

(22) Filed: May 5, 2008

(51) Int. Cl. G07C 3/02

(52) U.S. Cl. 377/16

(57) ABSTRACT

A run-time meter for monitoring at least the amount of time a piece of equipment has been operating. The run-time meter comprises a counter and a blind interface. The counter is actuated to begin counting when the piece of equipment operates. The counter is adapted to register run-time data including at least the cumulative amount of time the piece of equipment operates. The counter has a memory portion for storing the run-time data and for storing a unique identifier selectively associated with the piece of equipment. The blind interface is in communication with the counter to permit the run-time data to be extracted from the memory portion of the counter by an external reader while preventing a user from perceiving the run-time data via the blind interface.

### CROSS-REFERENCE TO RELATED APPLICATIONS

Not applicable.

### BACKGROUND

1. Field of the Invention

The present invention relates generally to devices, systems, and methods for the collection of data regarding the operation of equipment. More specifically, but not by way of limitation, the present invention relates to run-time meters for the collection of data indicative of at least the amount of time individual pieces of equipment have been operating, and systems and methods for implementing such run-time meters.

2. Brief Description of Related Art

Various pieces of equipment or machinery may be maintained, and may have their useful life measured, by reference to the number of hours such pieces of equipment and machinery have been operated. For example, backhoes, generators, forklifts, tractors, pumps, and the like may often have maintenance performed at various operating-hour intervals, such as, for example, having their oil changed every two hundred operating hours.

As will be appreciated by those skilled in the art, it is desirable to optimize maintenance intervals such that maintenance is performed often enough to minimize damage to machines and the resulting costs of repairs, but also such that maintenance is not performed more often than necessary to simultaneously minimize maintenance costs. In order to improve the optimization of maintenance, many find it beneficial to schedule maintenance intervals according to the cumulative number of operating hours a piece of equipment has undergone. The accurate scheduling of such maintenance intervals therefore depends on having an accurate record of the number of operating hours to which each piece of equipment has been subjected. As such, many attempts have been made in the prior art to develop various gauges and the like for monitoring the number of operating hours of a piece of equipment.

One such device includes a simple mechanical counter connected to a moving component of the piece of equipment, for example the driveshaft or the like, such that when the piece of equipment is operating, the counter is simultaneously operating to register the amount of time of such operation. Another device is an electrically-actuated mechanical counter connected to an electrical circuit of the piece of equipment, for example an ignition circuit or the like, such that when the piece of equipment is operating the counter is simultaneously operating to register the amount of time of such operation. Yet another device is an electronic or digital counter connected to an electrical circuit of the piece of equipment, for example an ignition circuit or the like, such that when the piece of equipment is operating the counter is simultaneously operating to register the amount of time of such operation.

Each of the foregoing devices generally includes a localized display integral to or attached to the counter itself that requires an individual to travel to each counter and read or visually examine the display to determine the cumulative number of operating hours of the piece of equipment (or in some cases, the number of operating hours since the last maintenance activity). A number of problems are inherent in this method of reading individual counters. For example, human error, such as mistakes in reading numbers, juxtaposition of numbers, and the like, can lead to entirely inaccurate readings that may result in maintenance being performed too soon or too late (potentially increasing either repair or maintenance costs unnecessarily).

Additionally, these prior art devices generally include only a single cumulative record of either (a) the number of hours the piece of equipment has been subject to during the course of its entire operational life, or (b) the number of cumulative operating hours since the counter was last reset. Where counters are intended to be reset after each maintenance activity, their accuracy is also subject to human error. For example, they may be accidentally or unintentionally reset between maintenance activities, maintenance technicians may forget to reset them, and the cumulative number of operating hours of a given machine over its entire life must be calculated from past records, further subjecting it to calculation errors and the product of a potentially large number of errors in taking the individual interval readings. As such, a need exists for devices, systems, and methods for improving the accuracy of operating-hour information collected from individual machines.

Additionally, reading individual counters on individual machines may require an inordinate amount of time, all of which one or more technicians must be paid for. For example, at a job site where equipment is located across a large area, one or more technicians will have to walk or drive from one piece of equipment to another and take readings from each individual counter. Additionally, because the number of operating hours may not increase at a known rate, such readings will have to be done for all equipment periodically, for example, as often as daily, leading to duplication of efforts and extensive amounts of technician time being spent just to collect the readings before even being able to begin the actual maintenance activities such as oil changes and the like. As such, a further need exists for devices, systems, and methods to improve the efficiency with which run-time data may be collected.

### BRIEF DESCRIPTION OF THE DRAWINGS

FIG. 1 is an exploded perspective view of a run-time meter constructed in accordance with the present invention.

FIG. 2 is a schematic diagram of a run-time meter constructed in accordance with the present invention.

FIG. 3 is a screenshot of an exemplary download having run-time data and various other pieces of data corresponding to a piece of a equipment and stored on a run-time meter in accordance with the present invention.

FIG. 4 is a handheld reader for extracting run-time data from run-time meters constructed in accordance with the present invention.

FIG. 5 is a pictorial diagram of an exemplary system constructed in accordance with the present invention for monitoring and collecting run-time data from a plurality of pieces of equipment.

### DETAILED DESCRIPTION OF THE INVENTION

The various embodiments of the present invention are described in detail in the following embodiments. The pieces of equipment and machinery listed above are merely exemplary and are not intended to be an exhaustive list. The present invention may be adapted to monitor and collect run-time data for a variety of pieces of equipment for which it may be desirable to schedule maintenance or consider operational life in terms of operating hours, for example, as opposed to miles.

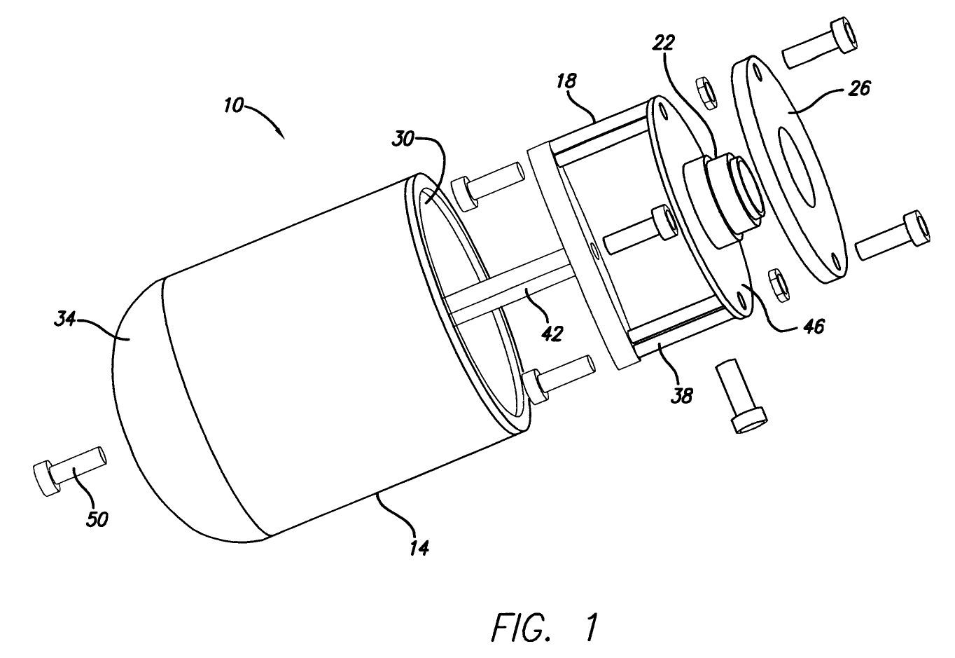

Referring now to the drawings, and more particularly to FIG. 1, shown therein and designated by the reference numeral 10 is a run-time meter constructed in accordance with the present invention. The run-time meter 10 may also be interchangeably referred to herein as the meter 10. The meter 10 preferably includes a housing 14, a support frame 18, a blind interface 22, and an end cover 26. The housing 14 is preferably formed with a hollow cylindrical shape and has an open end 30 and a substantially-closed end 34. The housing 14 is preferably formed of a durable, non-conductive, and substantially-rigid material such as PVC, carbon fiber, plastic, polymer, composite, or the like that is preferably substantially-impermeable to moisture. In other embodiments, it may be desirable to construct the housing 14 from a conductive material such as aluminum, steel, alloy, or the like. Additionally, in some embodiments, it may be desirable to provide the housing 14 with some flexibility and/or resiliency to improve the durability of the housing 14. In other embodiments, the housing 14 may be formed with any suitable shape, such as, for example, a box shape, a spherical shape, a fanciful shape, or the like.

The support frame 18 preferably includes a mounting portion 38 and an extension portion 42. The mounting portion 38 may be provided with any suitable shape that permits the mounting of various components, accessories, power sources, or the like. For example, the blind interface 22 preferably engages, and is supported by, the mounting portion 38 of the support frame 18. The mounting portion 38 preferably also includes a stabilizer 46 that engages the interior of the housing 14 to help ensure at least lateral stability of the support frame 18 within the housing 14. For example, in the embodiment shown, the stabilizer 46 is a circular disk corresponding in shape to the interior of the housing 14 so as to prevent lateral movement of the support frame 18 within the housing 14. The extension portion 42 preferably extends from the mounting portion 38 as shown such that when the meter 10 is assembled, the extension portion 42 extends to the substantially-closed end 34 of the housing 14 such that, when the meter 10 is assembled, the extension portion 42 is connected to the housing 14. For example, in the embodiment shown, the extension portion 42 is connected to the center of the substantially-closed end 34 of the housing 14 by a screw 50. In this way, the screw 50 cooperates with the stabilizer 46 to securely hold the support frame 18 in a predetermined relation to the housing 14, thereby similarly securing any components attached or supported by the mounting portion 38 of the support frame 18. Additionally, the relatively small size of the extension portion 42 permits additional components, wires, or the like to fit within the housing 14. The support frame 18 is preferably formed of a substantially-rigid and durable material such as, for example, aluminum, steel, alloy, carbon fiber, plastic, polymer, composite, or the like. In some embodiments it may be desirable to form the support frame 18, or a portion thereof, of a resilient or partially-resilient material such as, for example, rubber, elastomer, or the like, so as to reduce the amount of mechanical shock communicated between the housing 14 and any components engaging the support frame 18.

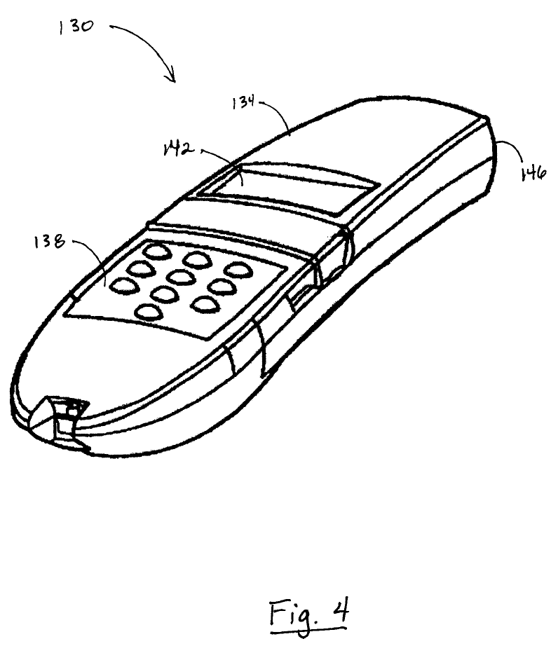

The blind interface 22 preferably permits the extraction of at least run-time data from the meter 10 by a handheld or similar device (e.g., see FIG. 4) for reading such data. Such a device preferably extracts and stores or registers the run-time data substantially simultaneously. The blind interface 22 is also preferably such that it is “blind” that is, prevents an individual from perceiving the run-time data via the blind interface 22. In this way, human error may be substantially eliminated from the process of collecting run-time data. In the embodiment shown, the blind interface 22 is a single-wire contact interface that permits electrical communication between the meter 10 and the reader device upon the reader device being placed in contact with the blind interface 22. Numerous other structures and devices may be used for the blind interface 22, as will be described in more detail below.

The end cover 26 is preferably shaped to correspond in size to the interior of the housing 14, and to cooperate with the stabilizer 46 and/or the blind interface 22 to substantially seal the open end 30 of the housing 14 when the meter 10 is assembled. To this end, the end cover 26 may be formed of any suitable material, such as, for example, rubber, polymer, elastomer, any material from which the housing 14 may be constructed, or the like. Additionally, the end cover 26 may include or cooperate with gaskets and the like to preferably substantially seal the open end 30 of the housing 14, or stated otherwise, to substantially prevent dust, moisture, debris, and the like from entering the housing 14. The end cover 26 and the various other components of the meter 10 may be connected, attached, engaged, or cooperatively associated with one another by any suitable means, such as, for example, screws, bolts, rivets, pins, interlocking tabs, adhesive, welds, threads, or the like.

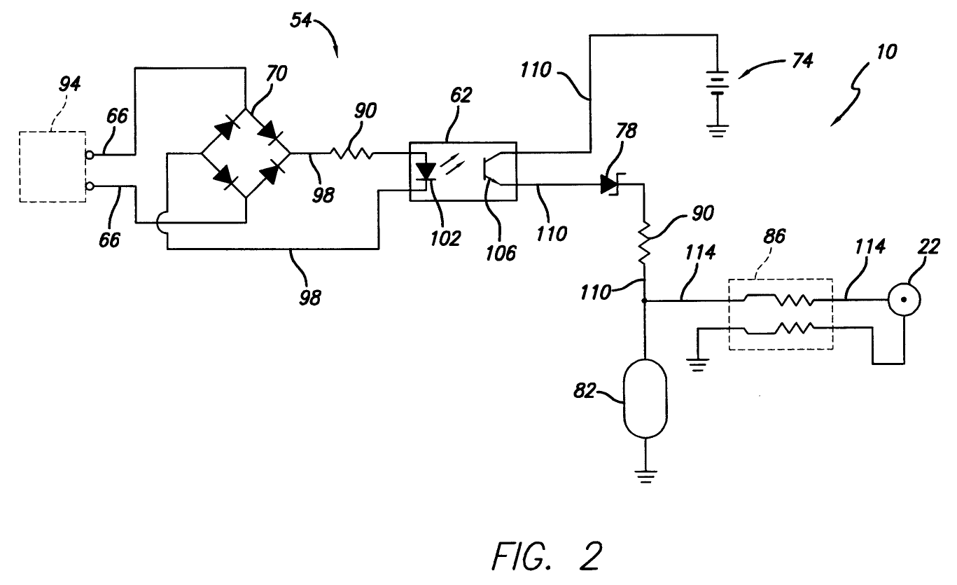

Referring now to FIG. 2, shown therein and designated by the reference numeral 10 is a schematic diagram of a run-time meter 10 constructed in accordance with the present invention. The embodiment of the run-time meter 10 shown is an alternating current (AC) model, that is, is designed to be connected to an AC circuit. However, in other embodiments, the run-time meter 10 may be formed to operate with direct current (DC) circuits. The run-time meter 10 preferably includes an input circuit 54, a data circuit 58, and an opto-isolator 62 coupling the input and data circuits 54 and 58. The input circuit 54 includes a pair of leads 66 and a rectifier 70. The data circuit 58 includes a battery 74, a regulator 78, a counter 82, a static discharge protector 86, and the blind interface 22 (see also FIG. 1). Each of the input and data circuits 54 and 58 also includes one or more resistors 90 as necessary or desired to achieve desirable operating characteristics of the meter 10.

Some of the components in meter 10 may be standard components and well known in the art, however, several components merit further description. The opto-isolator 62 may be any suitable device for protecting the data circuit 58 from the relatively-higher currents and/or voltages of the input circuit 54. The counter 82 may be any suitable device capable of counting and registering or storing at least the amount of time the piece of equipment is operating (the circuit 94 is energized). For example, the counter 82 may be analog or digital and may count in a variety of units, such as seconds, minutes, hours, or the like. The counter 82 preferably includes a memory portion (not separately shown) capable of storing run-time data that includes at least the amount of time the piece of equipment has operated. Additionally, it may be desirable for the counter 82 to be capable of counting and registering or storing the number of times the piece of equipment has been cycled on and off. It may further be desirable for the memory portion of the counter 82 to be capable of receiving and storing various other data regarding the piece of equipment to which the meter 10 is connected, as well as data regarding the meter 10 itself. One suitable device has a part number DS1994 and is available from Maxim Integrated Products, Inc. (formerly Dallas Semiconductor), headquartered at 120 San Gabriel Drive, Sunnyvale, Calif. 94086. In yet further embodiments, the counter 82 and the memory portion may be separate.

The blind interface 22 may be any device that permits the extraction of at least run-time data from the meter 10 by a handheld or similar device (not shown) for reading such data. Such a device (not shown) preferably extracts and stores or registers the run-time data substantially simultaneously. The blind interface 22 is also preferably such that it is “blind” that is, prevents an individual from perceiving the run-time data via the blind interface 22. In the embodiment shown, the blind interface 22 is a single-wire contact interface that permits electrical communication between the meter 10 and a reader device (not shown) upon the reader device (not shown) being placed in contact with the blind interface 22. One suitable device has a part number DS9092R and is available from Maxim Integrated Products, Inc. (formerly Dallas Semiconductor), headquartered at 120 San Gabriel Drive, Sunnyvale, Calif. 94086. Numerous other structures and devices may be used for the blind interface 22. For example, the blind interface 22 may be supplemented or substituted with one or more devices selected from the group consisting of: Bluetooth communication devices, WIFI communication devices, RFID communication devices, radio-wave communication devices, microwave communication devices, optical communication devices, and any combinations thereof that enable wireless extraction of data from the meter 10.

The static discharge protector 86 may be any suitable device that protects the meter 10 from static discharges that may, for example, be communicated to the meter 10 via the blind interface 22. One suitable device has a part number of DS9503P and is available from Maxim Integrated Products, Inc. (formerly Dallas Semiconductor), headquartered at 120 San Gabriel Drive, Sunnyvale, Calif. 94086. In other embodiments, the discharge protector 86 may be omitted, supplemented, or substituted with any suitable devices that function to protect the meter 10 from static discharges and the like.

In operation, the meter 10 is connected to an electrical circuit 94 of a piece of equipment, and in particular, preferably an electrical circuit 94 that is energized or has current flowing through it when the piece of equipment is running or operating and that is de-energized when the piece of equipment is not running. Specifically, the input circuit 54 of the meter 10 is connected to the circuit 94 by way of the leads 66. The leads 66 enable electrical communication between the circuit 94 and the rectifier 70. The rectifier 70 is preferably a full-wave rectifier that includes four diodes 98, as shown. However, the rectifier 70 can be a half-wave rectifier. As AC current flows through the leads 66, the rectifier 70 preferably modifies the waveform of the AC current to more closely resemble DC current. In turn, the output of the rectifier 70 is conducted to the opto-isolator 62 via conductive paths 98. As will be appreciated by those skilled in the art, it may be desirable to modify or omit the input circuit 54 to adapt the meter 10 for use with a DC circuit of a piece of equipment. As such, the rectifier 70 may be omitted, modified, supplemented, or replaced with any suitable device to enable the meter 10 to function as described herein with a DC circuit.

The opto-isolator 62 is also preferably of a type well known in the art that essentially isolates the data circuit 58 from the current flowing through the input circuit 54 and thereby protect more-sensitive components of the data circuit 58 from damage caused by power fluctuations, surges, and the like. The opto-isolator 62 preferably includes a photodiode 102 and a phototransistor 106. In general terms, when a current flows through the input circuit 54, it causes the photodiode 102 to emit light in the direction of the phototransistor 102. The light, in turn, is incident on the phototransistor 106 and causes the phototransistor 106 to become more conductive and permit current to flow through the data circuit 58, as will be described in more detail below.

In the data circuit 58, the battery 74, opto-isolator 62, and counter 82 are connected in series via conductive path 110. The battery 74 provides a voltage to the conductive path 110. The battery 74 may be provided with any suitable voltage and/or capacity, for example, three volts, 6 volts, or the like. As such, when the phototransistor 106 becomes conductive, the voltage will be applied to the regulator 78. The regulator 78 is preferably a Zener diode or similar device, such that when the voltage applied to the regulator 78 reaches a predetermined threshold value, the regulator 78 will permit current to flow at a voltage drop across the regulator 78 that is within a predetermined range. For example, the regulator 78 may be such that when the voltage applied to the regulator 78 reaches 3 volts, the regulator 78 will permit a current to flow through the regulator 78 with a voltage drop across the regulator 78 of about 2 volts plus or minus 0.25 volts

Once the voltage applied to the regulator 78 reaches the threshold value and the regulator 78 permits current to flow therethrough, the voltage drop across the regulator 78 will be applied to the counter 82 and current permitted to flow through the entire data circuit 58 such that the counter 82 is powered on. As such, while the piece of equipment is operating or running and the circuit 94 is energized, the counter 82 will count and register the amount of time the piece of equipment operates.

The blind interface 22 is also connected in series to the static discharge protector 86 and the counter 82 via conductive path 114. As such, when desired, a reader device (not shown) or the like is placed in contact with, or otherwise in communication with, the blind interface 22 and the run-time data downloaded from the counter 82.

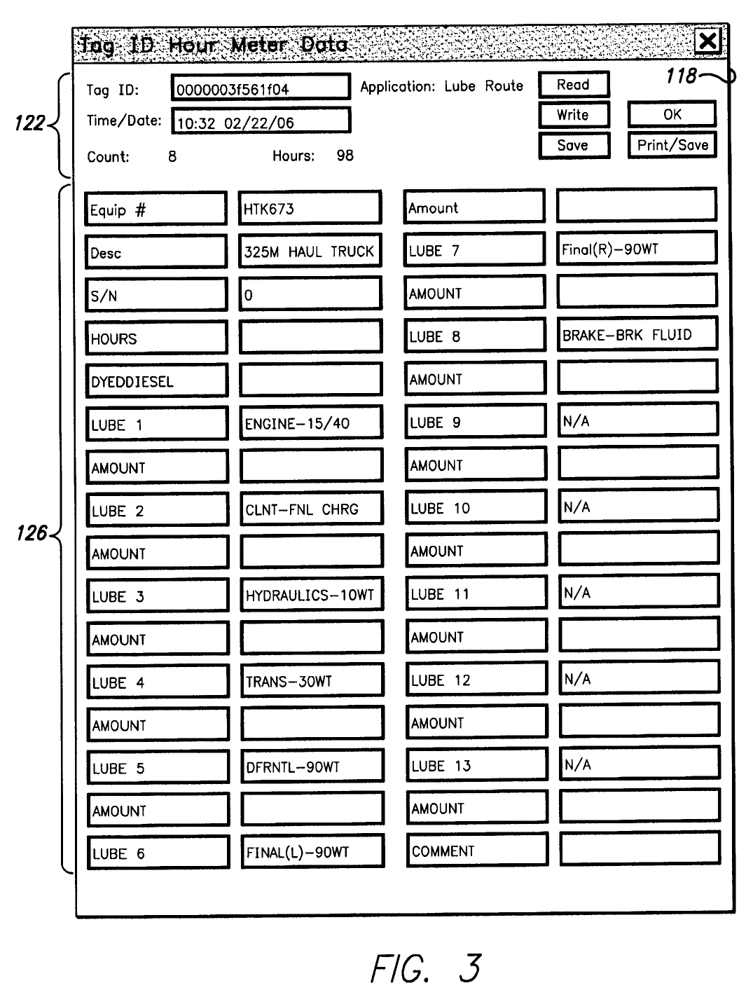

Referring now to FIG. 3, shown therein and designated by the reference numeral 118 is a screenshot of an exemplary download having run-time data and various other pieces of data corresponding to a piece of equipment and stored on a run-time meter 10. As shown, the screenshot includes a number of primary data fields 122. Each meter 10 preferably includes a unique identifier, as indicated by the field “Tag ID”. Similarly, the reader device preferably stores a time stamp that includes the date and time of each reading, as indicated by the field “Date/Time”. In one preferred embodiment, the time stamp is stored in the reader device and communicated to and/or stored in the meter 10. Additionally, the meter 10 preferably monitors and registers the elapsed time the piece of equipment has operated, as indicated by the field “Hours”. Although the field is depicted in hours, the operation or run-time may also be monitored and/or stored in any suitable units, such as, for example, minutes, seconds, hours, or the like, and any combinations thereof. Some embodiments of the meter 10 may also monitor and record the number of times the piece of equipment has been cycled on and off, as indicated by the field “Count”. In other embodiments, the primary data fields may include additional primary data fields 122, that is, data fields set and/or modified and/or updated by the counter 82, which may have additional functionality as well. For example, it may be desirable to monitor fuel consumption or relate fuel consumption to the number of operating hours to calculate rates of fuel consumption.

Additionally, a number of supplemental data fields 126 are preferably stored in the meter 10. As indicated by the text boxes for both the name and the content of each supplemental data field 126, the supplemental data fields 126 are optional and are preferably set and/or populated on an individual basis. For example, supplemental data fields 126 may be used to store equipment-specific data such as a model number, a description of the piece of equipment, a serial number, types of lubricant used by the piece of equipment, types of fuel for the piece of equipment, part numbers for various parts, filters, and the like used for the piece of equipment, and/or nearly any other useful information regarding the piece of equipment. In other embodiments, it may be desirable to store maintenance information regarding an organization or the piece of equipment. For example, it may be useful or desirable to store information such as the last time various maintenance activities were performed, the organization's typical interval for various maintenance tasks, any maintenance intervals specific to the piece of equipment, or any other information intended to improve the quality, consistency, or reliability of various maintenance activities with respect to the piece of equipment.

Referring now to FIG. 4, shown therein and designated by the reference numeral 130 is an exemplary reader device for use with run-time meters 10 of the present invention. Various handheld and other computing devices may be suitable for use as a reader device 130. However, given the inherently mobile and diverse nature of many jobsites and maintenance activities, a cordless handheld reader device 130 is preferred for use with the present invention. The reader device 130 preferably includes a housing 134 supporting a keypad 138, a display 142, and an interface 146. The housing 134 may be formed of any suitably durable material such as plastic or the like. The reader device 130 preferably further includes a processor (not shown) and a memory portion (not shown), both preferably supported within the housing 134 and cooperatively associated with the keypad 138 and the display 142.

The keypad 138 may be any suitable input device to permit a user, such as a maintenance technician, inspector, auditor, or the like, to interact with the reader device 130, for example, to extract run-time data from the meter 10 to the reader device 130, to output run-time data from the reader device 130 to a computer or external storage medium (not shown), or to view run-time data on the display 142 of the reader device 130. For example, the keypad 134 may be a 10-key pad such as is used on mobile phones, a QWERTY keypad, a touch-screen (that may further be integrated with the display 142), a rollerball input, a custom keypad, or any other suitable input.

The display 142 similarly may be any suitable type of display that permits and enables a user to operate the reader device 130. For example, in the preferred embodiment, the display 142 is capable of at least displaying options to a user in a format perceivable by the user that permits the user to select an action such as extracting data from a meter 10 or exporting data to a computer or the like (not shown). Additionally, the display 142 preferably permits a user to view at least a portion of the run-time data extracted from the meter 10. In other embodiments, the display 142 may be omitted entirely such that the reader device 130 merely extracts data from the meter 10 and then exports such run-time data to another device such as a computer.

The interface 146 preferably permits the reader device 130 to communicate with meters 10 to permit the reader device 130 to extract run-time data from the meters 10. As such, the interface 146 may be of nearly any type corresponding to the blind interface 22 of the meter(s) 10 with which the reader device 130 is intended to communicate. As described above with reference to the blind interface 22 of the meter 10, the interface 146 of the reader device 130 is preferably a contact interface that merely requires contact between the interface 146 and the blind interface 122. In other embodiments, the interface 146 may be supplemented or substituted with one or more devices selected from the group consisting of: Bluetooth communication devices, WIFI communication devices, RFID communication devices, radio-wave communication devices, microwave communication devices, optical communication devices, and any combinations thereof that enable wireless extraction of data from the meter 10.

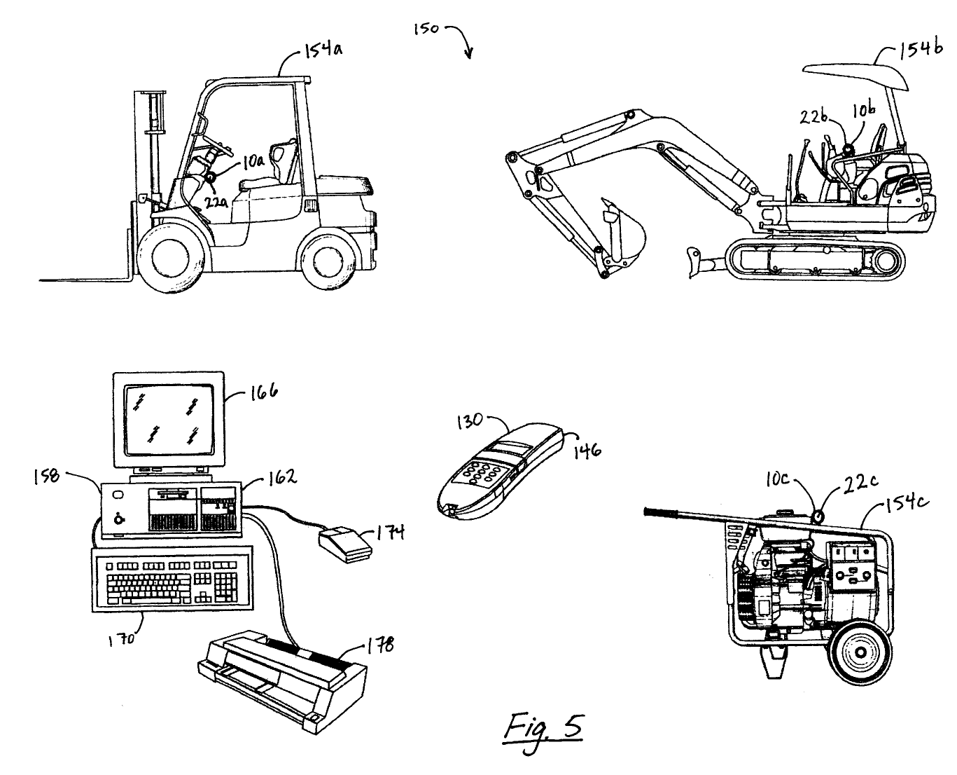

Referring now to FIG. 5, shown therein and designated by the reference numeral 150 is a system for monitoring and collecting run-time data from a plurality of pieces of equipment. The system 150 includes one or more reader devices 130, a plurality of run-time meters 10a, 10b, 10c, associated with a plurality of pieces of equipment 154a, 154b, 154c, and one or more computers 158. As described above, the reader device 130 is provided with an interface 146 for communicating with the blind interface, e.g. 22a, 22b, 22c, of each meter 10a, 10b, 10c.

The one or more computers 158 may include any suitable computer or computer systems. For example, the computer 158 shown is of the PC type and includes a desktop computing portion 162, a display 166, a keyboard input 170, a mouse input 174, and an output device 178, such as a printer. The computer 158 shown is merely exemplary and may be modified, omitted, supplemented, or the like with any suitable computing device or devices, such as, for example, laptop computers, mainframe computers, distributed computer systems, web-based computing systems, servers, or the like. Similarly, the computer 158 may run any suitable type of software for collecting at least the run-time data. Additionally, the computer 158 preferably runs software capable of storing, organizing, and monitoring the run-time data.

In one method of use, the system 150 generally operates as follows: One or more of the pieces of equipment 154a, 154b, 154c, are operated, generally but not necessarily in the normal course of business of an organization implementing the system 150. As the pieces of equipment are operated, the meters 10a, 10b, 10c, preferably collect run-time data regarding their respective pieces of equipment 154a, 154b, 154c. The run-time data preferable includes at least the amount of time the piece of equipment 154a, 154b, 154c has operated, and optionally may include the number of cycles the piece of equipment 154a, 154b, 154c has been cycled on and off, as well as various other pieces of information. At various intervals, one or more users (not shown) utilize one or more reader devices 130 to extract the run-time data from one or more of the meters 10a, 10b, 10c associated with the pieces of equipment 154a, 154b, 154c. In some embodiments, the one or more users may further reset the counters 82 within the meters 10a, 10b, 10c, for example, via the one or more reader devices 130.

Once the run-time data has been extracted from one or more of the pieces of equipment 154a, 154b, 154c, the run-time data is preferably exported from the reader device 130 to the computer 158. The reader device 130 may communicate with the computer 158 via any suitable means. For example, the reader device 130 preferably communicates with the computer 158 via the interface 146. By way of another example, the reader device 130 may be connected to the computer 158 via a USB cable or any other suitable cable. The run-time data may be exported to the computer 158 in any suitable format, such as, for example, tab-delimited format, comma separated values, one or more tables, one or more spreadsheets, or any other suitable format.

As described above, the extraction of run-time data from the meters 10a, 10b, 10c may be completed in different ways depending on the type of blind interface 22a, 22b, 22c utilized in the meters 10a, 10b, 10c, and corresponding interface 146 utilized in the one or more reader devices 130. The system 150 will preferably include meters 10a, 10b, 10c all having the same type of blind interface 10a, 10b, 10c such that a single type of interface 146 may be used for each of the one or more reader devices 130. In other embodiments, however, the system 150 may include a plurality of types of blind interfaces 22a, 22b, 22c in the meters 10a, 10b, 10c, and a corresponding plurality of types of interfaces 146 in the one or more reader devices 130. In such systems, the one or more reader devices 130 may each be provided with a plurality of types of interfaces 146 such that each reader device 130 is capable of communicating with two or more types of blind interfaces 22a, 22b, 22c used in the system 150. Likewise, the meters 10a, 10b, 10c may be provided with two or more types of blind interfaces 22a, 22b, 22c such that run-time data can be extracted therefrom by reader devices 130 having different types of interfaces 146.

Where the meters 10a, 10b, 10c include contact-type blind interfaces 22a, 22b, 22c, that require the interface 146 of the reader device 130 to be placed in contact with the blind interface 10a, 10b, 10c to extract run-time data, one or more users travel to a first machine 154a to extract run-time data from the corresponding meter 10a, then travel to a second machine 154b to extract run-time data from the corresponding meter 10b, and then travel to a third machine 154c to extract run-time data from the corresponding meter 10c.

In some embodiments utilizing types of blind interfaces 22a, 22b, 22c that permit wireless communication between the meters 10a, 10b, 10c and the reader device 130, one or more users travel to within communication range of a first machine 154a to extract run-time data from the corresponding meter 10a, then travel to within communication range of a second machine 154b to extract run-time data from the corresponding meter 10b, and then travel to within communication range of a third machine 154c to extract run-time data from the corresponding meter 10c. As will be appreciated by those skilled in the art, such wireless communication can significantly reduce the amount of time required to extract run-time data from meters 10a, 10b, 10c because a user may not be required to travel as much between pieces of equipment 154a, 154b, 154c since extraction of run-time data does not require that the reader device 130 physically contact the meters 10a, 10b, 10c.

In yet further embodiments enabling wireless communication between the meters 10a, 10b, 10c and the reader device 130, the blind interfaces 22a, 22b, 22c are enabled to communicate with one another such that the blind interfaces 22a, 22b, 22c can relay run-time data between one another and the reader device 130. For example, a user could travel to within communication range of the meter 10a and extract run-time data therefrom. Additionally, as long as the first meter 10a is within communication range of the second meter 10b, the reader device 130 extracts run-time data from the second meter 10b, via the first meter 10a. Similarly, as long as the third meter 10c is within communication range of the second meter 10b, the reader device 130 extracts run-time data from the third meter 10c, via the second meter 10b and the first meter 10a. The reader device 130 preferably extracts run-time data directly from all pieces of equipment 10a, 10b, 10c that are within communication range, and then extracts data from any further meters that are within communication range of a closer meter such that the closer meter can relay the run-time data to the reader device 130. In other embodiments, however, the reader device 130 may extract run-time data from meters 10a, 10b, 10c in any suitable fashion, e.g., directly or indirectly by way of an intermediate relaying meter, regardless of whether such a relay is necessary. Such relay capability may be enabled by any suitable means, such as, for example, by way of the Zigbee protocol or the like.

Although reference is made herein to extracting and exporting data, such terms are not intended to limit the methods of data transfer. Specifically, data may be “pushed” from, “pulled” to, or simultaneously “pushed” and “pulled” within the meaning of the terms extract and export, as used herein.

Although the foregoing invention has been described in some detail by way of illustration and example for purposes of clarity of understanding, it will be apparent to those skilled in the art that certain changes and modifications may be practiced without departing from the spirit and scope thereof, as described and claimed herein.

What is claimed is:

1. A run-time meter for monitoring at least the amount of time a piece of equipment has been operating, the run-time meter comprising:
a counter actuated to begin counting when the piece of equipment operates, the counter adapted to register run-time data including at least the cumulative amount of time the piece of equipment operates, the counter having a memory portion for storing the run-time data and for storing a unique identifier selectively associated with the piece of equipment; and
a blind interface in communication with the counter to permit the run-time data to be extracted from the memory portion of the counter by an external reader while preventing a user from perceiving the run-time data via the blind interface.

2. The run-time meter of claim 1, wherein the run-time data further includes the number of times the piece of equipment has been cycled on and off.

3. The run-time meter of claim 1, wherein the run-time meter is electrically connected to an equipment circuit that is energized when the piece of equipment is operating.

4. The run-time meter of claim 3, further comprising:
a rectifier in electrical communication with the equipment circuit;
a photodiode in electrical communication with the rectifier and the counter; and
an isolation circuit in electrical communication with the photodiode and with the counter, the isolation circuit for protecting the counter from power surges.

5. The run-time meter of claim 1, wherein the blind interface includes a housing having a contact side and a ground side such that when the ground side is electrically grounded, the external reader extracts the run-time data from the memory portion when the external reader contacts the contact side of the housing.

6. The run-time meter of claim 1, wherein the blind interface includes a wireless communication device such that the external reader extracts the run-time data by establishing wireless communication with the blind interface.

7. The run-time meter of claim 6, wherein the wireless communication device is capable of communicating with other run-time meters such that the wireless communication device is capable of relaying run-time data from other run-time meters to the external reader.

8. The run-time meter of claim 6, wherein the wireless communication device is selected from the group consisting of: Bluetooth communication devices, WIFI communication devices, RFID communication devices, radio communication devices, cellular communication devices, and optical communication devices.

9. A system for monitoring at least the amount of time each of a plurality of pieces of equipment has been operating, the system comprising:
a plurality of run-time meters each associated with one of the plurality of pieces of equipment, each run-time meter comprising:
a counter actuated to begin counting when the piece of equipment operates, the counter adapted to register run-time data including at least the cumulative amount of time the piece of equipment operates, the counter having a memory portion for storing the run-time data and for storing a unique identifier selectively associated with the piece of equipment; and
a blind interface in communication with the counter to permit the run-time data to be extracted from the memory portion of the counter by an external reader while preventing a user from perceiving the run-time data via the blind interface.

10. The system of claim 9, wherein the run-time data further includes the number of times the piece of equipment has been cycled on and off.

11. The system of claim 9, wherein each run-time meter is electrically connected to an equipment circuit that is energized when the piece of equipment is operating.

12. The system of claim 11, wherein each run-time meter further comprises:
a rectifier in electrical communication with the equipment circuit;
a photodiode in electrical communication with the rectifier and the counter; and
an isolation circuit in electrical communication with the photodiode and with the counter, the isolation circuit for protecting the counter from power surges.

13. The system of claim 9, wherein the blind interface of each run-time meter includes a housing having a contact side and a ground side such that when the ground side is electrically grounded, the external reader extracts the run-time data from the memory portion when the external reader contacts the contact side of the housing.

14. The system of claim 9, wherein the blind interface of each run-time meter includes a wireless communication device such that the external reader extracts the run-time data by establishing wireless communication with the blind interface.

15. The system of claim 14, wherein the wireless communication device of each run-time meter is capable of communicating with other run-time meters such that the wireless communication device is capable of relaying run-time data from other run-time meters to the external reader.

16. The system of claim 14, wherein the wireless communication device of each run-time meter is selected from the group consisting of: Bluetooth communication devices, WIFI communication devices, RFID communication devices, radio communication devices, cellular communication devices, and optical communication devices.

17. A method of monitoring at least the amount of time each of a plurality of pieces of equipment has been operating, the method comprising the steps of:
accessing a plurality of pieces of equipment, each associated with a run-time meter comprising:
a counter actuated to begin counting when the piece of equipment operates, the counter adapted to register run-time data including at least the cumulative amount of time the piece of equipment operates, the counter having a memory portion for storing the run-time data and for storing a unique identifier selectively associated with the piece of equipment; and
a blind interface in communication with the counter to permit the run-time data to be extracted from the memory portion of the counter by an external reader while preventing a user from perceiving the run-time data via the blind interface.
extracting with an external reader run-time data for a first piece of equipment from a first run-time meter;
extracting with the external reader run-time data for a second piece of equipment from a second run-time meter;
transferring from the external reader to a computer the run-time data for the first and second pieces of equipment.

18. The method of claim 17, wherein the run-time data further includes the number of times the piece of equipment has been cycled on and off.

19. The method of claim 17, wherein each run-time meter is electrically connected to an equipment circuit that is energized when the piece of equipment is operating.

20. The method of claim 19, wherein each run-time meter further comprises:
a rectifier in electrical communication with the equipment circuit;
a photodiode in electrical communication with the rectifier and the counter; and
an isolation circuit in electrical communication with the photodiode and with the counter, the isolation circuit for protecting the counter from power surges.

21. The method of claim 17, wherein the blind interface of each run-time meter includes a housing having a contact side and a ground side such that when the ground side is electrically grounded, the external reader extracts the run-time data from the memory portion when the external reader contacts the contact side of the housing.

22. The method of claim 17, wherein the blind interface of each run-time meter includes a wireless communication device such that the external reader extracts the run-time data by establishing wireless communication with the blind interface.

23. The method of claim 22, wherein the steps of extracting run-time data from the first run-time meter and extracting data from the second run-time meter are performed substantially simultaneously.

24. The method of claim 22, wherein the wireless communication device of each run-time meter is capable of communicating with other run-time meters such that the wireless communication device is capable of relaying run-time data from other run-time meters to the external reader.

25. The method of claim 24, wherein the steps of extracting run-time data from the first run-time meter and extracting data from the second run-time meter are performed substantially simultaneously, and wherein the first run-time meter relays the run-time data from the second run-time meter to the external reader.

26. The method of claim 22, wherein the wireless communication device of each run-time meter is selected from the group consisting of: Bluetooth communication devices, WIFI communication devices, RFID communication devices, radio communication devices, cellular communication devices, and optical communication devices.
